(19) United States
(12) Patent Application Publication
(10) Pub. No.: US 2023/0081266 A1
(43) Pub. Date: Mar. 16, 2023

(54) DETECTING FALSE IMAGES AND MALICIOUS EMBEDDED LINKS

(71) Applicant: INTERNATIONAL BUSINESS MACHINES CORPORATION, ARMONK, NY (US)

(72) Inventors: Jeffery Crume, Raleigh, NC (US); Jose F. Bravo, Old Greenwich, CT (US)

(21) Appl. No.: 17/447,311

(22) Filed: Sep. 10, 2021

(51) Int. Cl. H04L 29/06

(52) U.S. Cl. CPC H04L 63/1416

(57) ABSTRACT

A computer-implemented method, a computer system and a computer program product detect false images and malicious embedded links in communications. The method includes receiving an image from a server. The image includes a link with an address. The method also includes determining that the image is associated with an organization based on comparing the image to a set of verified images associated with the organization. In addition, the method includes determining that the address of the link is not associated with the organization based on comparing the address to a set of verified addresses associated with the organization. Lastly, the method includes displaying an alert on a device in response to the determination that the image is associated with the organization and the address is not associated with the organization.

### BACKGROUND

Embodiments relate generally to the field of computer security, and more specifically, to blocking phishing attacks by detecting false images and malicious embedded links within those images.

As the Internet may become more popular for everyday use and more commerce may flow online, it may also increase the possibility that network users are deceived into providing personal information through a technique known as phishing. A common phishing practice may be to solicit users with an email or other communication that may include an image that appears legitimate and/or has a link embedded in the image that may direct a user to a malicious or fraudulent source. The user may believe that they are conducting a normal business transaction or maintenance on an existing account but if the user clicks on the image, the user may be led to a website that aims to deceive users into giving over their personal information. As a result, the user's data may be compromised, and the user may be vulnerable to identity theft and the reputation of legitimate business organizations may be harmed.

### SUMMARY

An embodiment is directed to a computer-implemented method for detecting false images and malicious embedded links in communications. The method may include receiving an image from a server, wherein the image includes a link with an address. The method may also include determining that the image is associated with an organization based on comparing the image to a set of verified images associated with the organization. The method may further include determining that the address of the link is not associated with the organization based on comparing the address to a set of verified addresses associated with the organization. Lastly, the method may include displaying an alert on a device in response to the determination that the image is associated with the organization and the address is not associated with the organization.

In another embodiment, the method may include deleting the image in response to the determination that the image is associated with the organization and the address is not associated with the organization.

In a further embodiment, the method may include removing the address from the link in response to the determination that the image is associated with the organization and the address is not associated with the organization.

In yet another embodiment, an object recognition algorithm may be used to determine that the image is associated with the organization.

In still another embodiment, a text recognition algorithm may be used to determine that the address is not associated with the organization.

In addition to a computer-implemented method, additional embodiments are directed to a system and a computer program product for detecting false images and malicious embedded links in communications.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a block diagram of an example computer system in which various embodiments may be implemented.

FIG. 2 depicts a block diagram of a computing system that may be used to receive false images and addresses with respect to a phishing attack according to an embodiment.

FIG. 3 depicts a flow chart diagram for a process that detects false images and malicious embedded links in communications according to an embodiment.

FIG. 4 depicts a cloud computing environment according to an embodiment.

FIG. 5 depicts abstraction model layers according to an embodiment.

### DETAILED DESCRIPTION

As more and more legitimate business may be conducted through the Internet, phishing emails continue to present a problem for many users. As attackers get better, malicious emails look more and more indistinguishable from legitimate ones. One way they add the appearance of legitimacy is to include company logos or other images that correspond to the organization they are attempting to impersonate. This image may contain an embedded link, which the user believes will take them to the correct site but will, in fact, direct them to the attacker's site.

Phishing represents a fraudulent technique employed to obtain confidential transaction information, e.g., username, password, financial information, credit card information, from computer users for misuse. In phishing, the phisher employs a phishing server to send an apparently official electronic communication (such as an official looking email) to a user. For example, if a phisher wishes to obtain confidential information to access a user's bank account, the email may appear to come from a bank email address and contain official-looking logos and language to deceive the user into believing that the email is legitimate.

Further, the phisher's email may include language urging users to access the bank's website to verify some information or to confirm a transaction. The email may also include a link attached for the user to supposedly access the bank's website. However, when the user clicks on the link, the user may be taken instead to a fraudulent website set up in advance by the phisher. The fraudulent website, i.e., the phishing website, would then ask for confidential information from the user. Since the user may have been told in advance that the purpose of clicking on the link is to verify some account information or to confirm a transaction, many users would unquestioningly enter the requested information. Once the confidential information is collected by the phisher, the phisher can then use the information to commit fraud. For instance, money may be withdrawn from the bank account or goods purchased with the user's credit card information.

One way that phishing attacks may be stopped involves alert and knowledgeable users. Because phishing attacks may actually divert users to a website address that is different from an intended legitimate website address, a user may be able to spot the difference in the website addresses and may refuse to furnish the sensitive information. For instance, if the user sees an address such as “http://218.246.224.203/icons/cgi-bin/xyzbank/login.php” in the URL address bar of their web browser, that user may realize the address is different from the usual “http://www.xyzbank.com/us/cgi-bin/login.php”. However, many users are not sophisticated or always vigilant against such phishing attempts and relying on users to stay on guard against phishing attempts may be an inadequate response to phishing attacks.

URL filtering techniques may also be employed to detect whether a particular website is a known phishing website. For example, if a website with a certain IP address is known to be a phishing website, any attempt to access that website by a user, such as clicking on an image with an embedded link, may be instantly denied. However, URL filtering may require prior knowledge of the phishing website, with a focus on specifically identifying suspicious links to determine whether the address or URL in the link belongs to a known malicious site based upon a disallow list. In addition to the overhead and trouble of maintaining such a disallow list, if a phisher sets up a new website for the purpose of conducting phishing attacks, and the new website has a new address that has not yet been detected as a phishing website, URL filtering may not be able to detect this newly set up website as a phishing website. As a result, malicious sites may not show up on a disallow list until they have already caused damage that has been reported. A method that is more proactive and has the capability to determine that an address or URL is suspicious before any user ever clicks on the link may be a very useful and important improvement to the prevention of dangerous and costly phishing attacks. Such a method may also improve detection of phishing attempts by being more efficient as there is no need to store information about prior attempts or compile a running list of malicious addresses that should be disallowed. Such a method may also lead to a more efficient use of computer resources since processing power may also not need to be spent on independently verifying addresses or URLs and images in a list of allowable images and links.

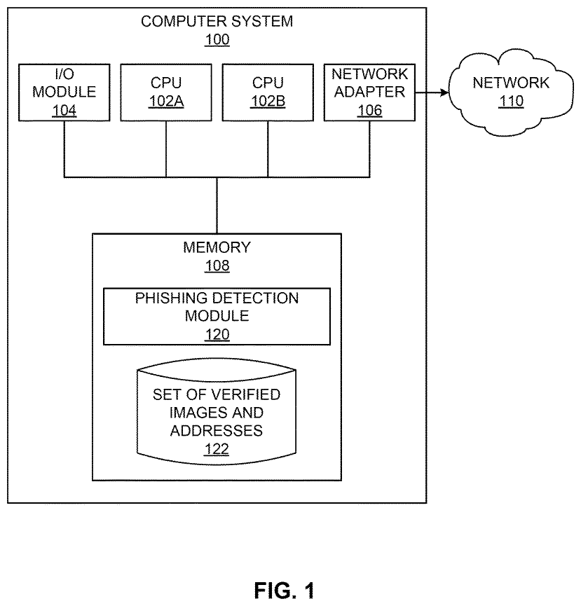

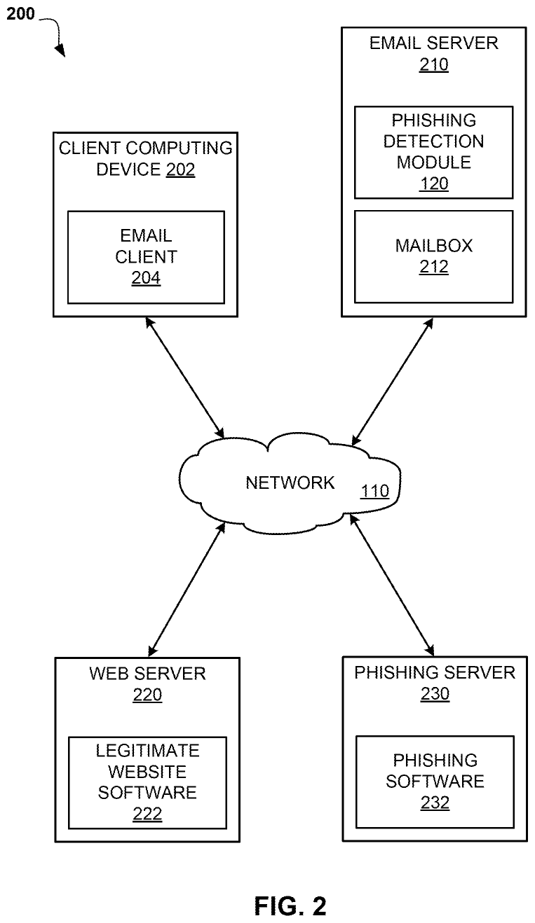

Referring now to FIG. 1, a block diagram of a computer server 100, in which processes involved in the embodiments described herein may be implemented, is shown. Computer server 100 may represent computer hardware, e.g., user computing device 202 or email server 210 or web server 220 in FIG. 2, that may run the software described in the embodiments. Computer server 100 may include one or more processors (CPUs) 102A-B, input/output circuitry 104, network adapter 106 and memory 108. CPUs 102A-B execute program instructions in order to carry out the functions of the present communications systems and methods. FIG. 1 illustrates an embodiment in which computer server 100 is implemented as a single multi-processor computer system, in which multiple CPUs 102A-B share system resources, such as memory 108, input/output circuitry 104, and network adapter 106. However, the present communications systems and methods may also include embodiments in which computer server 100 is implemented as a plurality of networked computer systems, which may be single-processor computer systems, multi-processor computer systems, or a mix thereof. Input/output circuitry 104 provides the capability to input data to, or output data from, computer server 100. Network adapter 106 interfaces computer server 100 with a network 110, which may be any public or proprietary LAN or WAN, including, but not limited to the Internet.

Memory 108 stores program instructions that may be executed by, and data that may be used and processed by, CPU 102A-B to perform the functions of computer server 100. Memory 108 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an Integrated Drive Electronics (IDE) interface, or a variation or enhancement thereof, such as enhanced IDE (EIDE) or Ultra-Direct Memory Access (UDMA), or a Small Computer System Interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a Fibre Channel-Arbitrated Loop (FC-AL) interface.

The contents of memory 108 may vary depending upon the function that computer server 100 is programmed to perform. In the example shown in FIG. 1, example memory contents are shown representing routines and data for embodiments of the processes described herein. However, it may be recognized that these routines, along with the memory contents related to those routines, may not be included on one system or device, but rather may be distributed among a plurality of systems or devices, based on well-known engineering considerations. The present communications systems and methods may include any and all such arrangements.

Included within memory 108 may be the phishing detection module 120 which may run the routines that are described in the embodiments below. Phishing detection module 120, as shown in the email embodiment of FIG. 2, may be integrated with an email service provider and/or within email client software such as email client 204. At the same time, phishing detection module 120 may access a set of verified images and addresses (or URLs) 122 as described below. It should be noted that the set of verified images and addresses 122 is shown as a local component within computer server 100 but this may not be required. Embodiments of the present invention may not store any information locally, or even at all, as verified images may be present on the network from other sources. It is only required that verified images and verified addresses or URLs be stored in some location to check against the received images described below, and the links that may be embedded in the images. Embodiments of the present invention do not store any information about past interactions, such as an allow or disallow list, nor do the embodiments independently verify the stored images. The set of verified images and addresses 122 may be in any form that holds necessary information about known organizations, such as company logos and/or verified addresses or URLs, as described below.

The communication network 110 may include various types of communication networks, such as a wide area network (WAN), local area network (LAN), a telecommunication network, a wireless network, a public switched network and/or a satellite network. The communication network 110 may include connections, such as wire, wireless communication links, or fiber optic cables. The network 110 may also include additional hardware not shown such as routers, firewalls, switches, gateway computers and/or edge servers. It may be appreciated that FIG. 2 provides only an illustration of one implementation and does not imply any limitations with regard to the environments in which different embodiments may be implemented. Many modifications to the depicted environments may be made based on design and implementation requirements. Accordingly, the communication network 110 may represent any communication pathway between the various components of the phishing attack example 200 in FIG. 2.

Referring to FIG. 2, an example 200 of a phishing attack on a user using an image with an embedded link attached to an email is shown according to an embodiment. In this example, a set of devices, including client computing device 202, email server 210, web server 220 and phishing server 230, may be connected to one another using network 110, described in more detail with respect to FIG. 1. One of ordinary skill in the art may recognize that there may be an unlimited number of devices, of each type depicted in FIG. 2, connected via the network but only one of each type of device is shown in FIG. 2 for illustrative brevity.

In the example of FIG. 2, the means of communication for the phishing attack may be an email. In this scenario, the target of the attack may be client computing device 202 but in a typical arrangement, the actual mailbox 212 where emails are collected and stored is on an email server 210 instead of on the client computing device 202. As such, an email client 204 may be loaded and stored on the client computing device 202 that may be used to navigate emails stored in the mailbox 212. In other embodiments, the mailbox 212 may reside on the client computing device 202 and the emails stored locally. The phishing detection module 120 is shown in FIG. 2 as being loaded and stored on the email server 210 but it should be noted that this module may be on the client computing device 202 as well and may be embedded within the email client 204. It is also not necessary for the email client and server to be on separate servers.

The phishing server 230 in this example may be a computer server that has been taken over by a human phisher and is under the human's control. The phishing software 232 may represent software that may send an email to an unsuspecting user but may also represent a phishing website that may attempt to fool the user into providing sensitive information, e.g., an account user ID, a password or an account number. In doing so, the phishing software 232 may appear to users as legitimate website software 222 and communications, or emails in this example, may use images to make a user believe that the user is conducting transactions with legitimate website software 222 through an address that leads to web server 220, when in fact the user is communicating with phishing software 232 using the address of phishing server 230.

To carry out the phishing attack depicted in FIG. 2, the phishing software 232 may send an official-looking email designed to convince a user that receives the email at mailbox 212 and views the email through email client 204 that the email comes from legitimate website software 222 at the address of web server 220. For example, the email may attempt to convince the user to update a real account that may be located at the business referenced by legitimate website software 222 with the address of web server 220 by clicking on an image with an embedded link to access a webpage, i.e., what the user believes is legitimate website software 222. If the user clicks on the image and follows the embedded link, the webpage that appears would then request the user to enter the user's confidential information related to the account, e.g., userid, password or account number.

However, since the email may not have come from the legitimate business and may instead have been generated by phishing software 232, and because the image may contain an embedded link to the address of phishing server 230, the user's confidential information may actually be sent to phishing software 232. Phishing software 232 may collect this user's confidential information, along with the sensitive information of any user that may follow the embedded link in the image, to allow the human phisher in control of phishing server 230 to commit fraud on the user.

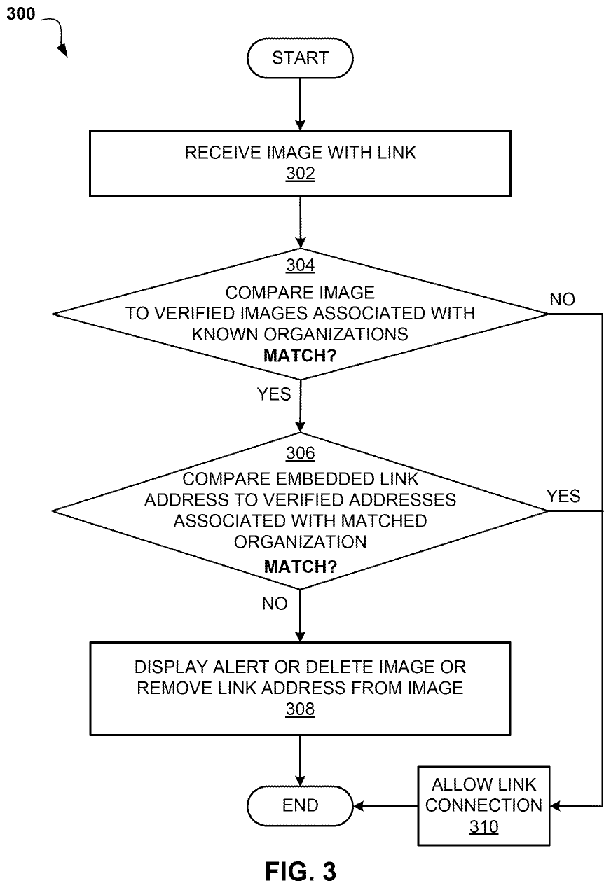

Referring to FIG. 3, an operational flowchart illustrating a process 300 for detecting false images and malicious embedded links in communications is depicted according to at least one embodiment. At 302, an image with an embedded link that includes an address, e.g., a uniform resource locator (URL), may be received by a user through a communication, which may be an email such as the embodiment described in FIG. 2. Images that do not have an embedded link with an address or URL in them may not be capable of directing the user to a fraudulent site where personal information can be collected. Therefore, it is also necessary for the image that may be received at 302 to have some address or URL embedded in the image that may redirect the user to a destination address when the image is clicked on. The image may be downloaded to the client computing device before being seen but may also be opened within the user's mailbox on the email server. In other embodiments, the image may be received through a text message on a smart phone or through any electronic means. One of ordinary skill in the art may appreciate that the communication need not be addressed to a specific user, a user may receive many kinds of unsolicited communications with images attached that may seem legitimate.

At 304, the image may be compared to known verified images, e.g., the set of verified images and addresses 122, to determine whether the image is recognized and associated with a known organization. As an example, the image that may be received may be a company logo. Using image recognition techniques such as optical character recognition (OCR) or object recognition, the image may be scanned to recognize the logo and check against verified company logos that may have been collected in a data set, e.g., a database. It should be noted that recognizable text may not be necessary in the image under analysis as object recognition techniques may recognize a logo in the absence of a caption or any text that may be included such as a company name. If the image is recognized as matching to a known organization, the process may continue to 306, but in the event that the image is not recognized, i.e., the image does not match to a known organization, the process ends, and no further verification may be done. In this scenario, the process moves to step 310, meaning that the embedded link is not checked, and the link is allowed to proceed.

Similarly, at 306, once the image has been matched to a known organization, the address or URL of the link embedded within the image may be compared to a set of known verified addresses, e.g., the set of verified images and verified addresses 122, to determine whether the embedded link or URL is associated with the same known organization as the image. This comparison may be done in tandem with the image verification in 304, including the step that once an image is identified as associated with a known organization, the list of addresses that may be checked by this step may be limited to verified addresses associated with the organization with which the image is associated. As an example, if the image is verified as the logo of a specific company, the embedded link or URL need not be compared to any addresses outside the verified addresses associated with that company. If the link address or URL is not recognized as matching to the same known organization, the process may continue to 308, but should the address match a verified address, the process also moves to step 310, meaning that the link is allowed to proceed.

In both of steps 304 and 306, a set of known verified images and/or addresses is described. One of ordinary skill in the art may recognize that while searching the Internet or broadly surfing the Internet, many servers of any type may track user behavior and capture addresses and images that are both legitimate and malicious. This information may be widely available such as through various commercial Web search services or may be available in a proprietary method for use by specific applications. In either event, embodiments of the present invention may not independently verify images or addresses or even store lists of either verified or unverified images or addresses but rather rely on the existence of verified images and addresses. It is only necessary that lists of verified images and/or verified addresses with respect to recognized known organizations may exist and that said lists may be available for use in verifying the received image and embedded link. Similarly, in the embodiment of FIG. 2, it is not necessary that the set of verified images and addresses (or URLs) 122 in FIG. 1 be maintained locally or even on any of the servers shown in FIG. 2. In fact, it is not necessary that there exist a centralized group of images or addresses for the purpose of verification. For example, web searches using everyday commercial services with search terms as simple as a company name, or the image that may be collected at 302, may return results that recognize and verify the image that was collected. In step 304, it is only necessary to compare the image that may be received to a set of verified images or the embedded address or URL for the purpose of determining whether the image is from a legitimate source, e.g., matching a recognized known organization. Similarly, in step 306, it is only necessary to compare the address or URL that may be embedded in the image to a set of verified addresses or URLs for the purpose of determining whether the address or URL is legitimate. i.e., the address or URL matches to the known organization to which the image has been matched.

At 308, an embodiment of the present invention may display an alert in response to a determination that an embedded address or URL does not match to a known organization. For instance, a user that may have clicked on a link where the image and/or address or URL has been determined to be malicious and a potential phishing attack may be presented with a conspicuous warning dialog box on the computer screen of the user's computing device warning the user of the likely phishing attack. The alert may take any form that is obvious to a user and may cause the user to take any necessary action to protect against a phishing attack, such as manually deleting an email or an image or simply not following the embedded link. In another embodiment, the embedded address or URL may be disabled to make the address or URL inactive. For instance, the address or URL that is embedded in the image may be removed such that nothing happens when the image is clicked. In a further embodiment, the image, along with its embedded link, may be automatically deleted once it has been determined to be false or contain a malicious embedded link. This deletion may be permanent or may be a move to a folder that may be designated as “trash” and subject to regularly scheduled deletion at a later time.

As should be apparent from the flow of the process, step 308 may only take place if both the condition of 304 is met, i.e., the image is recognized as matching to a known organization, AND the condition of 306 is not met, i.e., the embedded link address is determined to not match the known organization to which the image has been matched in 304. Should the image not match to a known organization, or if the image matches to a known organization and the embedded link address matches to the same organization, the user may be connected through to the destination that is in the embedded link, which is shown on the flow chart diagram as step 310. In addition to allowing the connection to be completed, any set of known verified images and/or addresses that was used to make either determination may be updated to indicate the results of the determination of the embodiments, e.g., notifying an administrator of the set of verified images and addresses 122 that a connection was successful.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

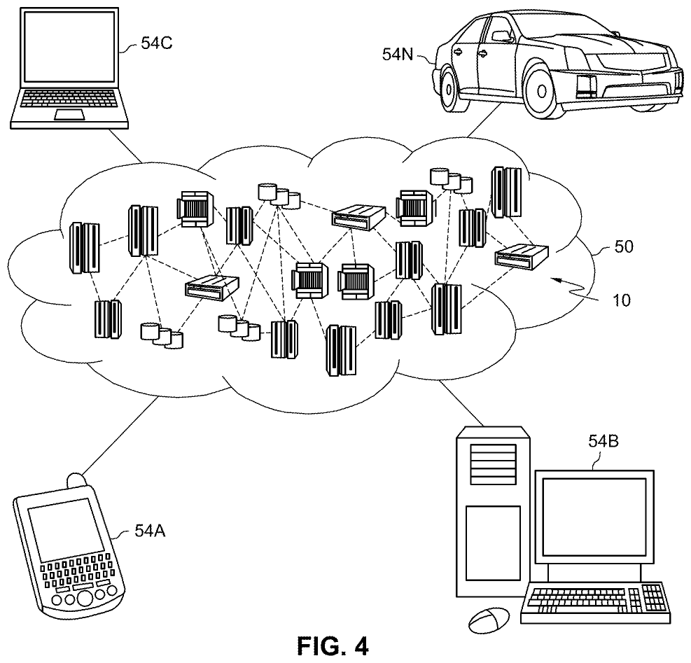

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

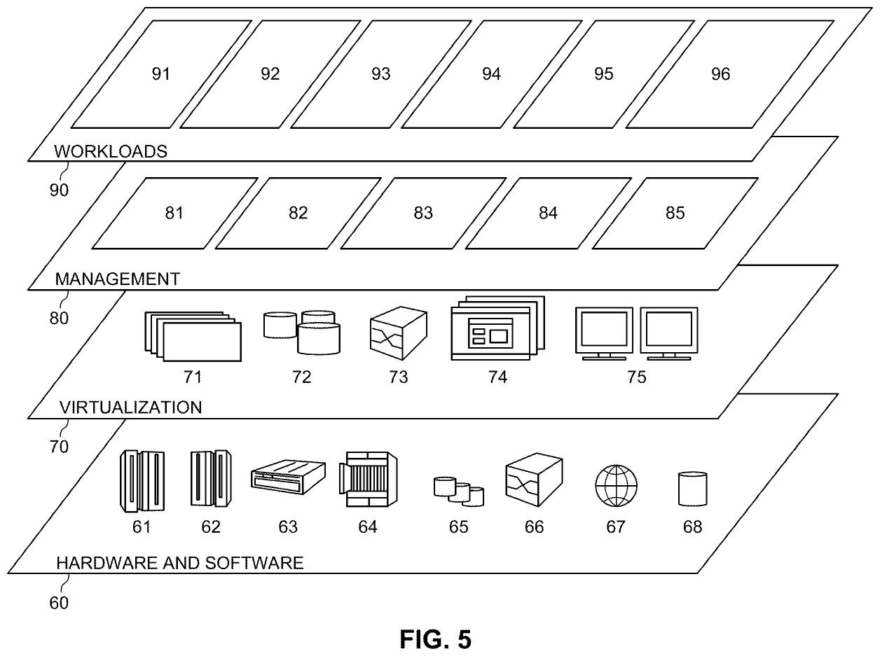

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components.

Examples of hardware components include: mainframes 61; RISC (Reduced Instruction Set Computer) architecture based servers 62; servers 63; blade servers 64; storage devices 65; and networks and networking components 66, such as a load balancer. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include mapping and navigation 91; software development and lifecycle management 92; virtual classroom education delivery 93; data analytics processing 94; transaction processing 95; and phishing detection modules 96, which may refer to detecting false images and malicious embedded links in communications.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for detecting false images and malicious embedded links in communications, comprising:
receiving an image from a server, wherein the image includes a link containing an address;
determining that the image is associated with an organization based on comparing the image to a set of verified images associated with the organization;
determining that the address is not associated with the organization based on comparing the address to a set of verified addresses associated with the organization; and
in response to the image being associated with the organization and the address not being associated with the organization, displaying an alert on a device.

2. The computer-implemented method of claim 1, wherein in response to the image being associated with the organization and the address not being associated with the organization, deleting the image.

3. The computer-implemented method of claim 1, wherein in response to the image being associated with the organization and the address not being associated with the organization, removing the address from the link.

4. The computer-implemented method of claim 1, wherein an object recognition algorithm is used to determine that the image is associated with the organization.

5. The computer-implemented method of claim 1, wherein a text recognition algorithm is used to determine that the address is not associated with the organization.

6. The computer-implemented method of claim 1, wherein in response to determining that the image is associated with the organization, updating the set of verified images.

7. The computer-implemented method of claim 1, wherein in response to determining that the address is associated with the organization, updating the set of verified addresses.

8. A computer system for detecting false images and malicious embedded links in communications, comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
receiving an image from a server, wherein the image includes a link containing an address;
determining that the image is associated with an organization based on comparing the image to a set of verified images associated with the organization;
determining that the address is not associated with the organization based on comparing the address to a set of verified addresses associated with the organization; and
in response to the image being associated with the organization and the address not being associated with the organization, displaying an alert on a device.

9. The computer system of claim 8, wherein in response to the image being associated with the organization and the address not being associated with the organization, deleting the image.

10. The computer system of claim 8, wherein in response to the image being associated with the organization and the address not being associated with the organization, removing the address from the link.

11. The computer system of claim 8, wherein an object recognition algorithm is used to determine that the image is associated with the organization.

12. The computer system of claim 8, wherein a text recognition algorithm is used to determine that the address is not associated with the organization.

13. The computer system of claim 8, wherein in response to determining that the image is associated with the organization, updating the set of verified images.

14. The computer system of claim 8, wherein in response to determining that the address is associated with the organization, updating the set of verified addresses.

15. A computer program product for detecting false images and malicious embedded links in communications, comprising:
a computer readable storage device having program instructions embodied therewith, the program instructions executable by a processor to cause the processor to perform a method comprising:
receiving an image from a server, wherein the image includes a link containing an address;
determining that the image is associated with an organization based on comparing the image to a set of verified images associated with the organization;
determining that the address is not associated with the organization based on comparing the address to a set of verified addresses associated with the organization; and
in response to the image being associated with the organization and the address not being associated with the organization, displaying an alert on a device.

16. The computer program product of claim 15, wherein in response to the image being associated with the organization and the address not being associated with the organization, deleting the image.

17. The computer program product of claim 15, wherein in response to the image being associated with the organization and the address not being associated with the organization, removing the address from the link.

18. The computer program product of claim 15, wherein an object recognition algorithm is used to determine that the image is associated with the organization.

19. The computer program product of claim 15, wherein a text recognition algorithm is used to determine that the address is not associated with the organization.

20. The computer program product of claim 15, wherein in response to determining that the image is associated with the organization, updating the set of verified images.
